(19) United States
(12) Patent Application Publication
(10) Pub. No.: US 2014/0144728 A1
(43) Pub. Date: May 29, 2014

(54) BRAKE TORQUE SENSING SYSTEM

(71) Applicant: Toyota Motor Engineering & Manufacturing North America, Inc., (US)

(72) Inventor: David Szeto, Torrance, CA (US)

(73) Assignee: Toyota Motor Engineering & Manufacturing North America, Inc., Erlanger, KY (US)

(21) Appl. No.: 13/686,978

(22) Filed: Nov. 28, 2012

(51) Int. Cl. B60T 17/22; B60T 8/17

(52) U.S. Cl. CPC B60T 17/22; B60T 8/17
USPC 188/1.11 R; 701/70

(57) ABSTRACT

The invention includes a system and method for controlling a brake system for a motor vehicle. The system determines actual brake torque by measuring the strain in an elongated portion of a suspension knuckle, the elongated portion being attached to a brake caliper which engages a disc brake to create the actual brake torque. The system can use the determined actual brake torque to best apply a proper blend of brake torques between the caliper and disk brake and a regenerative braking system through a closed loop analysis method.

### FIELD OF THE INVENTION

The present invention is related to a system and method for controlling an automotive braking system, in particular to a system which determines actual brake torque by measuring a strain in a suspension knuckle component, the determined actual torque is used to control the brake system which can include a mechanical braking and a regenerative braking system.

### BACKGROUND OF THE INVENTION

Automotive braking systems are generally known in the art. These systems can have sensors to determine the brake torque developed by a brake pad in contact with a brake rotor in the system. These sensors are often mounted on a brake caliper or on a brake caliper bracket. Placing a sensor on a brake caliper can create problems in that it may not accurately measure a brake torque as the brake pad wears or if a different brake pad is installed. In addition, mounting a sensor on a brake caliper bracket requires the use of extra component parts. As such, a new brake sensor design that increases the accuracy of the data provided by the sensor and also reducing the cost of the system via a reduction in the overall number of component parts would be desirable.

It is also known in the art to utilize a blended brake system having a mechanical brake, such as a hydraulically actuated caliper and disc brake, and a regenerative braking system, such as an electric motor used as a generator to produce electricity which is then captured by the system as the vehicle decelerates. Current systems, however, do not monitor the brake torque created by the mechanical brake component of the blended system, thereby creating an opportunity to increase the efficiency of the system as a whole.

### SUMMARY OF THE INVENTION

An automotive braking system and method of the present invention includes a suspension knuckle with an elongated portion which mounts to a brake caliper, the brake caliper applies force on a disc brake rotor to slow a vehicle. A strain gauge is mounted on the elongated portion of the suspension knuckle. The strain gauge detects a strain in the elongated portion of the suspension knuckle, which is used to determine an actual brake torque produced by the brake caliper as it engages the disc brake rotor.

An output signal from the strain gauge on the elongated portion of the suspension knuckle is sent to an amplifier to be amplified. The amplified signal is sent to an electronic control unit. The electronic control unit performs numerous functions with the data received from the amplified strain gauge signal including, but not limited to, properly balancing the mix between the brake torque created by the brake caliper engaging the disc brake and a brake torque created by a regenerative braking system. It is appreciated that the electronic control unit can be a centralized unit which controls numerous sub systems, such as the mechanical braking system, the regenerative braking system, etc. It is further appreciated that the electronic control unit can alternatively be a plurality of sub control units located in various discrete locations, each sub control unit controlling a limited number of sub systems, the plurality of sub control units communicating and working with each other.

Operation of the braking system can includes driver providing an input, by depressing a brake pedal for example, the input creating a requested brake torque signal which is sent to the electronic control unit. The electronic control unit then sends a signal as a function of the requested brake torque signal to the regenerative braking system, an electric motor used as a generator for example, and if necessary to a hydraulically actuated caliper and disc brake. Oftentimes the requested brake torque is in excess of what can be provided by the regenerative braking system, so additional required brake torque can be supplied and/or is needed to be provided by the caliper and disk brake.

The actual brake torque created by the caliper and disk brake is measured with the strain gauge on the elongated portion of the suspension knuckle. Specifically, the actual brake torque can be determined or measured by amplifying the output or strain signal produced or detected with the strain gauge, sending the amplified signal to the electronic control unit which calculates the actual brake torque. The electronic control unit also compares the actual brake torque with the required brake torque and adjusts the hydraulic pressure in the caliper to make the actual brake torque equal to the required brake torque after comparing the torque values.

It can be appreciated by one skilled in the art that the measured or actual brake torque of the current invention can also be utilized for other automotive control systems beyond blending the regenerative braking and mechanical braking systems. Some other uses include, but are not limited to, control of an all wheel drive system to distribute brake torque along individual wheels for increased vehicle control, control and feedback of the individual brakes in a vehicle with a stability control system, monitoring road and traction conditions, and analysis of the braking system to ensure the braking system is functioning properly.

### BRIEF DESCRIPTION OF THE DRAWINGS

FIG. 1 is a schematic illustration of a perspective view of a suspension knuckle according to an embodiment of the present invention;

FIG. 2 is an enlarged view of the circled portion in FIG. 1 illustrating the elongated portion of the suspension knuckle;

FIG. 3 is a schematic illustration of a powertrain system of an embodiment of the present invention; and

FIG. 4 is an illustration of a flow chart for a method of practicing an embodiment of the present invention.

### DETAILED DESCRIPTION OF THE INVENTION

The invention includes a system and method for controlling a brake system for a motor vehicle. The system determines actual brake torque by measuring the strain in an elongated portion of a suspension knuckle, the elongated portion being attached to a brake caliper which engages a disc brake to create the actual brake torque. The system uses the determined actual brake torque to best apply a proper blend of brake torques between the caliper and disk brake and a regenerative braking system through a closed loop feedback control method.

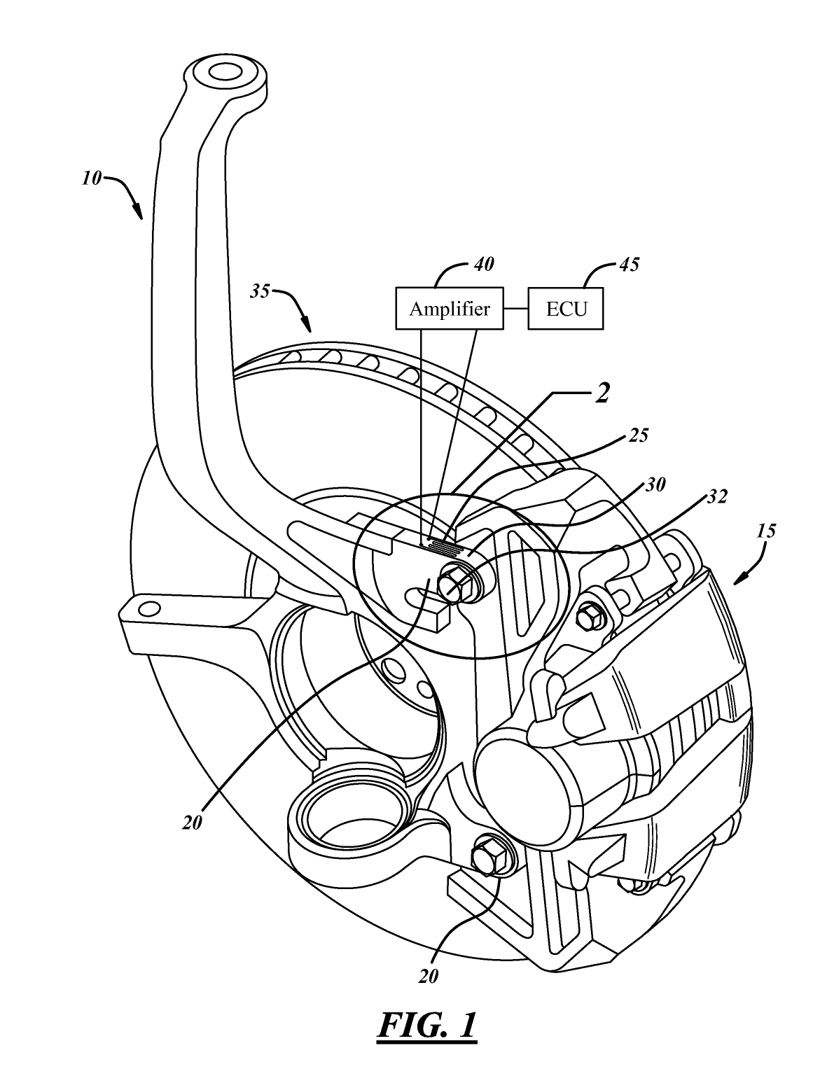

FIG. 1 shows a suspension knuckle 10 of the preferred embodiment. The suspension knuckle 10 has an elongated portion 20. A brake caliper 15 is attached to the elongated portion 20, for example by using a threaded fastener 32. A strain gauge 25 is mounted on the elongated portion 20. In the preferred embodiment the strain gauge 25 is on a top portion 30 of the elongated portion 20, however this is not required. The strain gauge 25 can be attached to the elongated portion of the suspension knuckle by an adhesive such as epoxy, or it may be provided as an individual bolt-on unit, or it may be attached by any other method known to those skilled in the art.

The brake caliper 15 is operable to apply a force to a brake disc 35, and thereby create a brake torque which slows the vehicle (not shown) and also creates a strain in the elongated portion 20 of the suspension knuckle 10, to which the brake caliper 15 is attached. The stain created in the elongated portion 20 is detected by the stain gauge 25 as known to those skilled in the art. In addition, a strain signal from the strain gauge 25 is transmitted and amplified by an amplifier 40 and also sent to an electronic control unit 45.

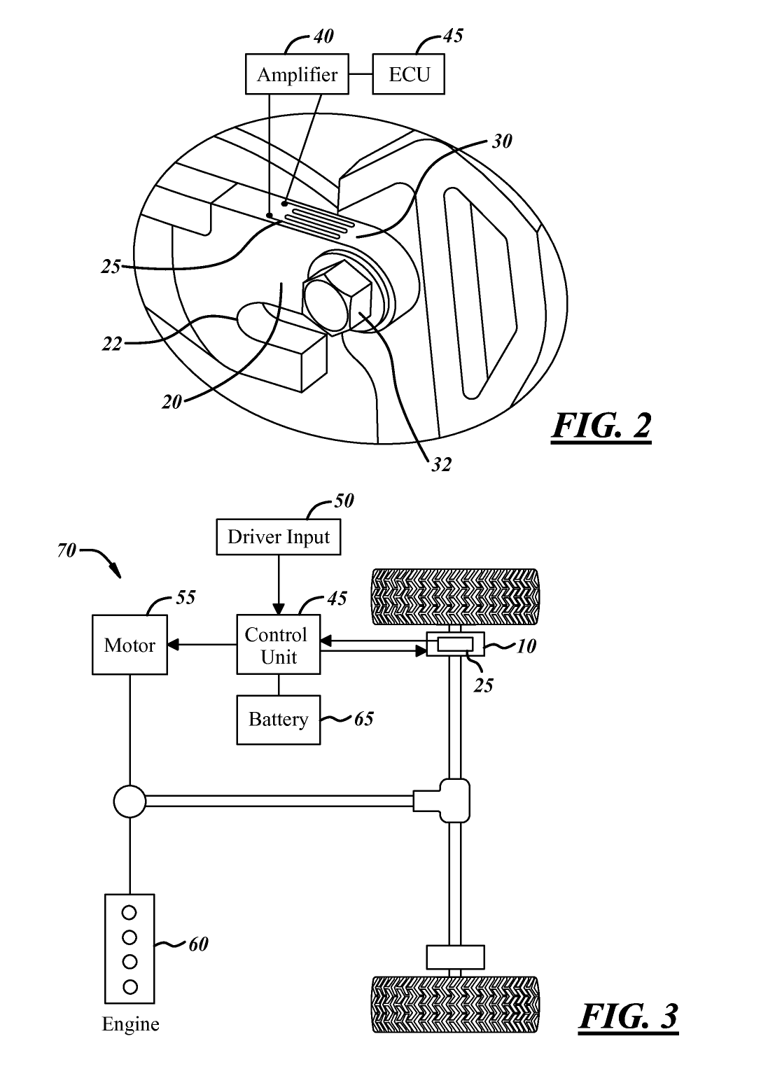

FIG. 2 shows a close up of the elongated portion 20 of the suspension knuckle 10 shown in FIG. 1 with the strain gauge 25 mounted on a top portion 30 of the elongated portion 20. In the preferred embodiment, the strain gauge 25 is entirely contained between the threaded fastener 32 connecting the elongated portion 20 to the brake caliper 15 on one end, and by a terminal portion 22 of the elongated portion 20 on the other end. When the brake caliper 15 is applied or engages the brake disc 35 it creates a strain in the elongated portion 20 and the strain is measured by the strain gauge 25. It is appreciated that the suspension knuckle 10 can be analyzed using finite element analysis, or any other method known to the art, whereby a strain in the elongated portion is correlated to a known applied force to the elongated portion 20. This known applied force is correlated to an actual brake torque value. The value of the actual brake torque is calculated by the electronic control unit 45 which receives the strain signal and has correlation tables preprogrammed. In addition, the results of the finite element analysis can be verified by empirical testing of the suspension knuckle 10.

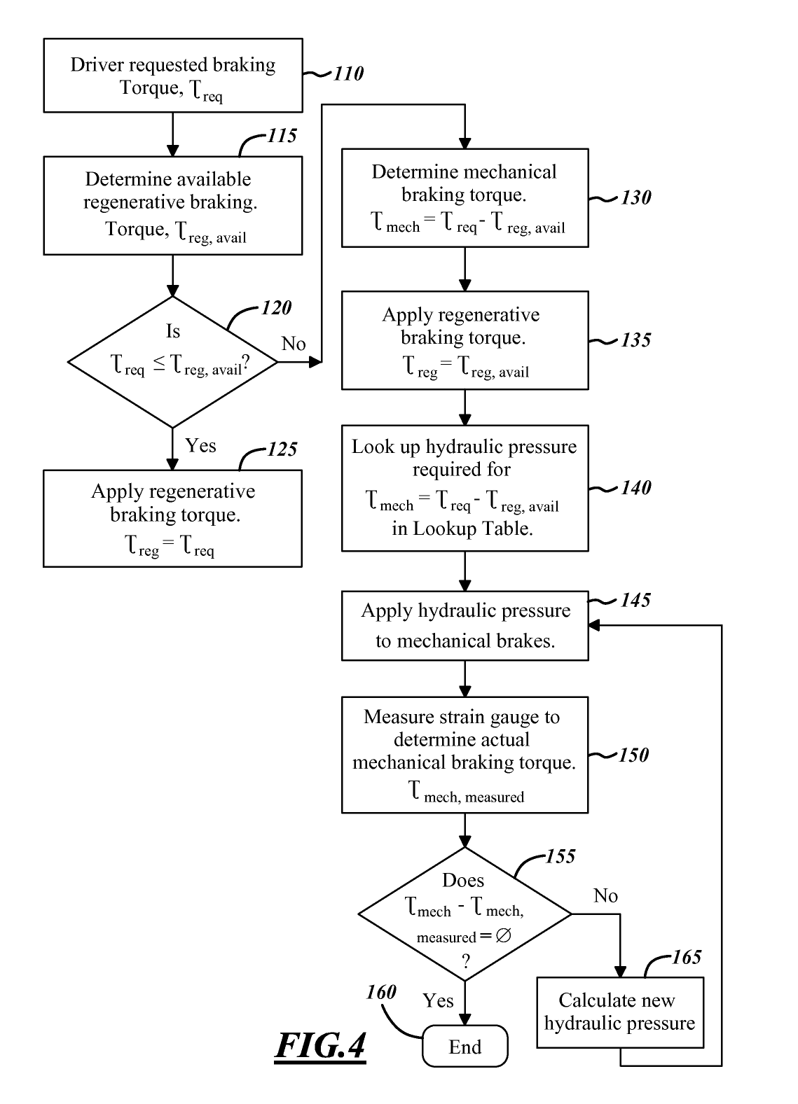

In the preferred embodiment the brake torque measuring system shown in FIGS. 1 and 2 is utilized in a hybrid powertrain system with a blended braking system as illustrated in FIG. 3. The blended braking system of FIG. 3 produces a brake torque in a hybrid powertrain system 70 by creating a brake torque from a mechanical braking system and a regenerative braking system. In the preferred embodiment shown in FIG. 3 the mechanical brake can be a disc brake with a caliper (not shown) mounted on the suspension knuckle 10. The regenerative brake system can utilize a motor 55 which is used as a generator. The braking system of the preferred embodiment shown in FIG. 3 also includes a driver input 50 where a driver of the motor vehicle inputs a requested brake torque signal to the system, the driver input is received by the control unit 45. The control unit 45 then outputs a brake control signal to the motor 55, and to the caliper with a disc brake on the suspension knuckle 10. It is appreciated that the electric signal from the electronic control unit 45 can be sent to a master cylinder (not shown) which is in fluid hydraulic communication with caliper. It is further appreciated that when the motor 55 is used as a generator it creates electric power which can be sent back to a battery 65 to be stored for later use.

The brake torque created by the caliper and disc brake on the suspension knuckle 10 creates a strain in the suspension knuckle 10 which is measured by the strain gauge 25. The signal from the strain gauge 25 can be amplified and sent to the control unit 45 for verification of proper brake torque creation by the disc brake. This feedback loop from the strain gauge 25 to the control unit 45 allows a proper brake blending between the disc brake on the suspension knuckle 10 and the brake torque created by the motor 55 when used as a regenerative braking system.

It is appreciated that the powertrain system 70 shown in FIG. 3 can be a hybrid system where power to propel the vehicle is generated both by a motor 55 and an engine 60, or in the alternative the powertrain system can be a purely electric system that does not have an engine 60. It should be further appreciated that the information fed back from the strain gauge 25 to the control unit 45 can allow increased brake control and efficiency in a standard motor vehicle not having a regenerative braking system, for example on a vehicle stability control system in a motor vehicle with a traditional powertrain.

FIG. 4 shows a method for operating a blended brake control system of the present invention. In an initial step 110 a driver inputs a requested brake torque to the system. The system then determines how much brake torque is available from the regenerative braking system of the blended brake system as shown in box 115. The available regenerative brake torque can be determined based on physical characteristics and limitations of the regenerative braking system itself, such as the battery charge state, the battery temperature, the motor temperature, the motor speed, etc. The available regenerative brake torque can also be determined by desired performance characteristics, such as the driving performance or feel. The available regenerative brake torque can be determined using a combination of the above, thereby enabling optimum driver satisfaction while operating the system within safe parameters.

The next step is a determination 120 as to whether the requested brake torque is less than or equal to the available regenerative brake torque. If the requested brake torque is less than or equal to the available regenerative brake torque, then regenerative brake torque is applied as shown in box 125. If the requested torque is greater than the amount of available regenerative brake torque, the system determines a required brake torque to be applied by a mechanical braking system, such as a caliper and disk brake, as shown by box 130. The required brake torque is equal to the requested brake torque from box 110 minus the available regenerative brake torque of box 115.

The determined regenerative brake torque is then applied through the regenerative braking system as shown by box 135. Also applied is the required mechanical brake torque. However, in order to apply the required torque by the mechanical braking system, the required brake torque signal is correlated with a required hydraulic pressure determined from a lookup table as demonstrated by box 140. The correlated hydraulic pressure is then applied to the mechanical braking system 145 creating an actual brake torque, the value of which can be measured by a strain gauge on the elongated portion of the suspension knuckle as shown in box 150. The value of the measured actual brake torque of box 150 is compared with the required brake torque from box 130 as shown in box 155. If the required brake torque from box 130 matches the measured actual brake torque from box 150, the method is completed. If the required brake torque of box 130 does not match the measured actual brake torque of box 150, a new hydraulic pressure is calculated, as shown by box 165, and sent to box 145. The new hydraulic pressure is calculated based on the differences between the initial required brake torque of box 130 and the measured actual brake torque of box 150. If the measured actual brake torque of box 150 is greater than the required brake torque of box 130, the hydraulic pressure is reduced. If the measured actual brake torque of box 150 is less than the required brake torque of box 130, the hydraulic pressure is increased. This loop of applying a hydraulic pressure, comparing the actual torque to the required torque, and calculating a new hydraulic pressure can then be repeated until the required brake torque and the measured actual brake torque are equal.

The foregoing drawings, discussion, and description are illustrative of specific embodiments of the present invention but they are not meant to be limitations upon the practice thereof. Numerous modifications and variations of the invention will be readily apparent to those of skill in the art in view of the teaching presented herein. It is the claims, including all equivalents, which define the scope of the invention.

1. A brake torque control apparatus for a motor vehicle comprising:
a suspension support knuckle having at least one elongated portion,
a strain gauge mounted to at least one of the elongated portions,
a control unit operable to receive a signal from the strain gauge, and
a brake caliper mounted on the suspension knuckle and operable to apply a force on a brake disc to create an actual brake torque,
the strain gauge operable to measure a strain of the elongated portion to which it is mounted when the brake caliper applies the force onto the brake disc, whereby the measured strain of the elongated portion by the strain gauge is used to calculate a value of the actual brake torque by the control unit.

2. The brake torque control apparatus of claim 1, wherein the strain gauge is mounted on a top portion of the elongated portion of the suspension knuckle.

3. The brake torque control apparatus of claim 1, wherein the strain gauge is mounted on between a bolt and a terminal portion of the elongated portion of the suspension knuckle.

4. The brake torque control apparatus of claim 1, wherein the value of the actual brake torque is compared to a required brake torque by the control unit.

5. The brake torque control apparatus of claim 4, wherein the force applied by the brake caliper to the brake disc is adjusted by the control unit based on the comparison of the measured brake torque and the required brake torque.

6. The brake torque control apparatus of claim 5, wherein the required brake torque is determined by a driver input.

7. The brake torque control apparatus of claim 5, wherein the required brake torque is determined by a driver input and an available regenerative braking system torque.

8. The brake torque control apparatus of claim 7, wherein the available regenerative braking system torque is created by an electric generator.

9. A method for controlling a braking system of a motor vehicle, the method comprising:
providing a driver input, a suspension knuckle with a strain gauge mounted on an elongated portion of the suspension knuckle, a mechanical brake mounted to the suspension knuckle,
determining a requested brake torque from the driver input,
determining a required brake torque,
applying an actual brake torque with the mechanical brake,
calculating a value of the actual brake torque based on a strain of the elongated portion of the suspension knuckle determined with the strain gauge,
comparing the required brake torque to the value of the actual brake torque, and
adjusting the applied actual brake torque created by the mechanical brake based on the comparison of the requested brake torque and the measured brake torque.

10. The method of claim 10 further comprising:
providing a regenerative braking system,
determining an available regenerative braking system torque created by the regenerative braking system before determining a required brake torque.
